(19) United States
(12) Patent Application Publication
(10) Pub. No.: US 2010/0073813 A1
(43) Pub. Date: Mar. 25, 2010

(54) PERPENDICULAR MAGNETIC RECORDING MEDIA HAVING A CAP LAYER FORMED FROM A CoPtCr ALLOY

(76) Inventors: Qing Dai, San Jose, CA (US); Mohammad T. Mirzamaani, San Jose, CA (US); Kai Tang, San Jose, CA (US); Jinliu Wang, San Jose, CA (US)

Correspondence Address: DUFT BORNSEN & FISHMAN, LLP, 1526 SPRUCE STREET, SUITE 302, BOULDER, CO, 80302, US

(21) Appl. No.: 12/233,959

(22) Filed: Sep. 19, 2008

(51) Int. Cl. G11B 5/127; G11B 5/706; G11B 5/65; G11B 5/66; B05D 5/12

(52) U.S. Cl. 360/110; 428/846; 428/834; 428/828; 427/131; G9B/5.04

(57) ABSTRACT

Perpendicular magnetic recording (PMR) media and methods of fabricating PMR media are described. The PMR media includes, among other layers, a perpendicular magnetic recording layer and a cap layer that are exchange coupled. The magnetic recording layer and the cap layer may be exchange coupled through direct contact, or may be exchange coupled over a coupling layer. In either embodiment, the cap layer is formed from a CoPtCr alloy having a concentration of Cr in the range of about 15-22 at %.

### BACKGROUND OF THE INVENTION

1. Field of the Invention

The invention is related to the field of magnetic disk drive systems and, in particular, to perpendicular magnetic recording (PMR) media having a cap layer formed from a CoPtCr alloy having a high concentration of Cr.

2. Statement of the Problem

One type of recording media presently used in magnetic recording/reproducing apparatuses is longitudinal magnetic recording media. Longitudinal magnetic recording media includes a magnetic recording layer having an easy axis of magnetization parallel to the substrate. The easy axis of magnetization is the crystalline axis that is aligned along the lowest energy direction for the magnetic moment. Another type of recording medium is perpendicular magnetic recording (PMR) media. PMR media includes a magnetic recording layer having an easy axis of magnetization oriented substantially perpendicular to the substrate. Hexagonal Close Packed (HCP) Co-alloys are typically used as the magnetic recording layer for both longitudinal and perpendicular recording. The easy axis of magnetization for these materials lies along the c-axis or <0001> direction.

PMR media is generally formed on a substrate with a soft magnetic underlayer (SUL), one or more interlayers, and a perpendicular magnetic recording layer. The soft magnetic underlayer (SUL) serves to concentrate a magnetic flux emitted from a main pole of a write head and to serve as a flux return path back to a return pole of the write head during recording on the magnetic recording layer. The interlayers (also referred to as seed layers) serve to control the size of magnetic crystal grains and the orientation of the magnetic crystal grains in the magnetic recording layer. The interlayers also serve to magnetically de-couple the SUL and the magnetic recording layer. The magnetic recording layer is the layer in which bits are stored based on the orientation of the magnetization of individual magnetic grains.

Because the magnetic recording layer has a magnetization that is oriented parallel to magnetic fields used to write to the media, reversing the magnetization of the magnetic recording layer is difficult. To assist in reversing the magnetization of the magnetic grains in the magnetic recording layer, some PMR media also includes a cap layer that is exchange coupled to the magnetic recording layer. The cap layer is typically formed from a CoPt alloy, such as CoPt, CoPtCr, CoPtCrB, etc. The cap layer may directly contact the magnetic recording layer, or a coupling layer may be fabricated between the cap layer and the magnetic recording layer. When a coupling layer is used, the structure is sometimes referred to as an exchange spring structure.

For an exemplary exchange spring structure, a coupling layer formed from CoRu or a similar material is fabricated between the magnetic recording layer and the cap layer. The coupling layer controls the amount of exchange coupling between the cap layer and the magnetic recording layer. The cap layer typically has a lower coercivity than the magnetic recording layer. Thus, when a magnetic field is applied to the media to reverse the magnetization of the magnetic recording layer, the magnetization of the cap layer begins to reverse first, which in turn exerts a torque on the magnetization of the magnetic recording layer to assist in reversing the magnetization.

To achieve a high level of magnetic recording performance within the PMR media, materials are used for the cap layer that exhibit a high saturation magnetization. One material used that exhibits a high saturation magnetization is a CoPtCrB alloy with a relatively low Cr composition, such as 12-13 at % of Cr. To keep noise low, a relatively high B composition is used, such as 7-10 at %. Although a cap layer comprised of a CoPtCrB alloy having the relatively low Cr composition exhibits good magnetic recording performance, the cap layer may be susceptible to corrosion, such as in high temperature and high humidity conditions. It would therefore be desirable to fabricate PMR media that is more resistant to corrosion.

### SUMMARY

Embodiments of the invention solve the above and other related problems with a cap layer of perpendicular magnetic recording (PMR) media that is formed from a CoPtCr alloy having a high concentration of Cr. A high concentration of Cr is defined as in the range of about 15-22 at %. The high concentration of Cr in the CoPtCr alloy maintains superior magnetic recording performance. At the same time, the CoPtCr alloy having a high concentration of Cr is less susceptible to corrosion than previously-used alloys. With the increase in Cr concentration, a CoPtCr alloy with no B or a lower concentration of B (up to 6 at %) may be used in the cap layer. The cap layer with the higher concentration of Cr, and no or a lower concentration of B demonstrates the properties of high saturation magnetization and low noise.

One embodiment of the invention comprises PMR media that includes the improved cap layer. The PMR media includes, among other layers, a perpendicular magnetic recording layer and a cap layer that are exchange coupled. The magnetic recording layer and the cap layer may be exchange coupled through direct contact, or may be exchange coupled over a coupling layer. In either case, the cap layer is formed from a CoPtCr alloy having a concentration of Cr in the range of about 15-22 at %. Implementing the cap layer with this higher concentration of Cr, as compared to prior cap layers, provides PMR media with improved corrosion resistance characteristics. The CoPtCr alloy described above may have a concentration of B in the range of 0-6 at %.

Another embodiment of the invention comprises a method of fabricating PMR media. The method includes depositing a soft magnetic underlayer (SUL) on a substrate, and depositing one or more interlayers on the SUL. The method further includes depositing a perpendicular magnetic recording layer on the interlayers which has an easy axis of magnetization oriented substantially perpendicular to the substrate. The method further includes depositing a cap layer. The cap layer is formed from a CoPtCr alloy having a concentration of Cr in the range of about 15-22 at %. The cap layer may be deposited on the magnetic recording layer, or may be deposited on a coupling layer.

The invention may include other exemplary embodiments described below.

### DESCRIPTION OF THE DRAWINGS

The same reference number represents the same element or same type of element on all drawings.

FIG. 1 illustrates a magnetic disk drive system in an exemplary embodiment of the invention.

FIG. 2 is a cross-sectional view of a PMR disk in an exemplary embodiment of the invention.

FIG. 3 is a cross-sectional view of a PMR disk with an exchange spring structure in an exemplary embodiment of the invention.

FIG. 4 is a cross-sectional view of a PMR disk in another exemplary embodiment of the invention.

FIG. 5 is a flow chart illustrating a method of fabricating a PMR disk in an exemplary embodiment of the invention.

FIG. 6 is a flow chart illustrating another method of fabricating a PMR disk in an exemplary embodiment of the invention.

FIG. 7 is a graph illustrating the corrosion characteristics of a CoPtCr alloy.

### DETAILED DESCRIPTION OF THE INVENTION

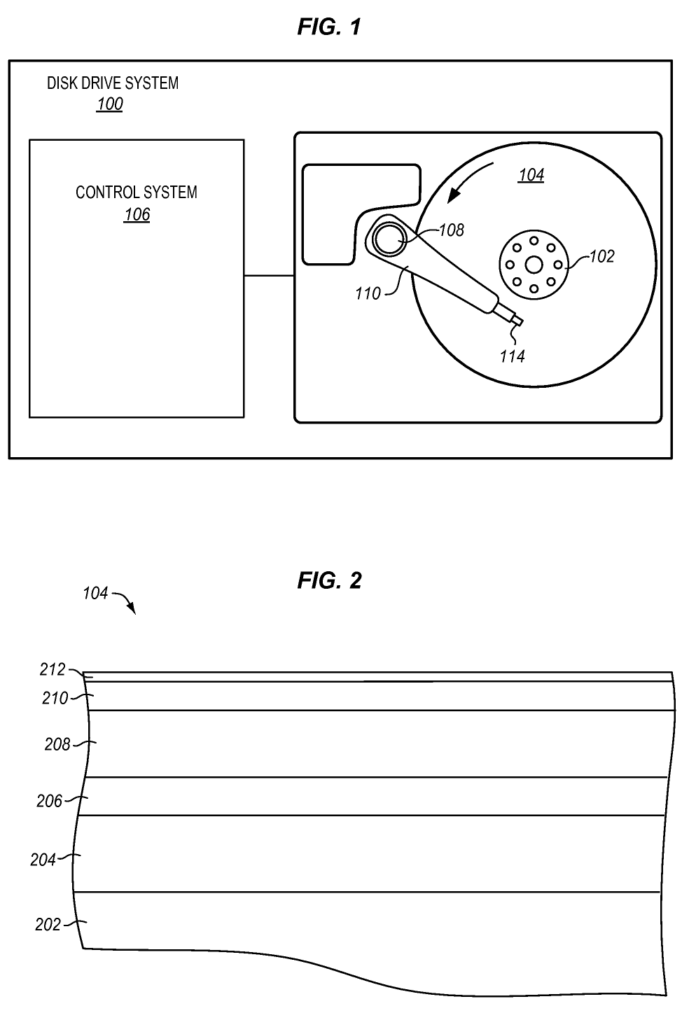

FIGS. 1-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a magnetic disk drive system 100. Disk drive system 100 includes a spindle 102, a PMR disk 104, a control system 106, an actuator 108, a suspension arm 110, and a slider 114 having an assembly of write and read heads. Spindle 102 supports and rotates PMR disk 104 in a direction indicated by the arrow. A spindle motor (not shown) rotates spindle 102 according to control signals from control system 106. Slider 114 is mounted on suspension arm 110, and actuator 108 is configured to rotate suspension arm 110 in order to position the assembly of write and read heads over a desired data track on PMR disk 104. Disk drive system 100 may include other components not shown in FIG. 1, such as a plurality of PMR disks, actuators, suspension arms, and sliders.

When PMR disk 104 rotates, an air flow generated by the rotation of PMR disk 104 causes slider 114 to fly on a cushion of air at a very low elevation (fly height) over the rotating PMR disk 104. As slider 114 flies on the air, actuator 108 moves suspension arm 110 to position a write head (not shown) and a read head (not shown) over selected data tracks on PMR disk 104. The write and read heads write data to and read data from, respectively, data tracks on PMR disk 104. Processing circuitry connected to the write and read heads then operates according to a computer program to implement writing and reading functions.

Although PMR disk 104 is shown as a disk in FIG. 1, those skilled in the art will appreciate that PMR media may take on other forms in other embodiments.

FIG. 2 is a cross-sectional view of PMR disk 104 in an exemplary embodiment of the invention. FIG. 2 shows just an example of the layers of PMR disk 104, and those skilled in the art will appreciate that more or less layers may be used for PMR disks. In this embodiment, PMR disk 104 includes a substrate 202, which is the base upon which the other materials are deposited. For example, substrate 202 may be comprised of a nonmagnetic metal, such as aluminum or an aluminum alloy, or may be comprised of a nonmagnetic material, such as glass, ceramics, silicon, etc. PMR disk 104 further includes a soft magnetic underlayer (SUL) 204 that is formed on substrate 202. SUL 204 acts in conjunction with a write head to increase the perpendicular field magnitude and improve the field gradient generated by a write head passing over the PMR disk 104. There may be an adhesion layer or another type of layer between SUL 204 and substrate 202.

PMR disk 104 further includes one or more interlayers 206, a perpendicular magnetic recording layer 208, a cap layer 210, and an overcoat 212. Interlayers 206 control the orientation and grain diameter of the magnetic recording layer 208, and serve to decouple magnetic recording layer 208 and SUL 204. Magnetic recording layer 208 comprises one or more materials that have an easy axis of magnetization oriented substantially perpendicular to substrate 202. Magnetic recording layer 208 is typically formed from a Co-alloy and may contain elements such as Cr and Pt as well as oxides such as SiO₂. Cap layer 210 is exchange coupled to magnetic recording layer 208 and functions to improve the write-ability of magnetic recording layer 208, such as by assisting in the reversal of magnetizations in magnetic recording layer 208. Overcoat 212 protects the underneath layers, such as from head to disk contact.

In this embodiment, cap layer 210 is formed from a CoPtCr alloy having a concentration of Cr in the range of about 15-22 at %. In contrast, the concentrations of Cr in prior cap layers were in the range of 12-13 at %. The higher concentration of Cr in cap layer 210 advantageously improves the corrosion resistance of PMR disk 104 while maintaining good magnetic performance. The alloy used for cap layer 210 may consist entirely of CoPtCr, or may include other elements. For example, the alloy used for cap layer 210 may consist of CoPtCrB, where the concentration of Cr is in the range of about 15-22 at %, and the concentration of B is in the range of about 0-6 at %. Even with the no or a lower concentration of B as compared to prior art cap layers, cap layer 210 exhibits high saturation magnetization and low noise.

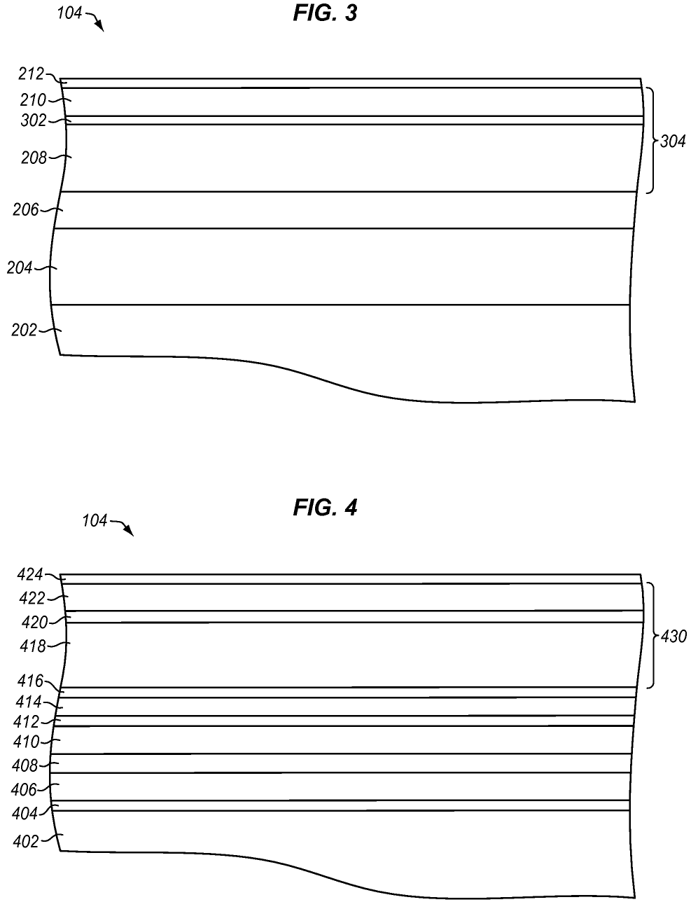

In FIG. 2, cap layer 210 is shown as directly contacting magnetic recording layer 208, which does not have to be the case. In other embodiments, cap layer 210 may be separated from magnetic recording layer 208 by a coupling layer to form an exchange spring structure, which is illustrated in FIG. 3.

FIG. 3 is a cross-sectional view of PMR disk 104 with an exchange spring structure in an exemplary embodiment of the invention. As in FIG. 2, PMR disk 104 includes a substrate 202, an SUL 204, one or more interlayers 206, a perpendicular magnetic recording layer 208, a cap layer 210, and an overcoat 212. In addition, a coupling layer 302 is fabricated between cap layer 210 and magnetic recording layer 208. The combination of magnetic recording layer 208, coupling layer 302, and cap layer 210 (also referred to as an exchange spring layer) form an exchange spring structure 304.

Coupling layer 302 is adapted to control or regulate the exchange coupling between cap layer 210 and magnetic recording layer 208. Coupling layer 302 may be formed from a CoRu alloy or a similar material that controls the exchange coupling between cap layer 210 and magnetic recording layer 208. Cap layer 210 has a lower coercivity than magnetic recording layer 208. Thus, when a magnetic field is applied to the media to reverse the magnetization of magnetic recording layer 208, the magnetization of cap layer 210 begins to reverse first, which in turn exerts a torque on the magnetization of magnetic recording layer 208 to assist in reversing the magnetization.

In this embodiment, cap layer 210 again is formed from a CoPtCr alloy having a concentration of Cr in the range of about 15-22 at %, and a concentration of B in the range of about 0-6 at %.

FIG. 4 is a cross-sectional view of PMR disk 104 in another exemplary embodiment of the invention. This embodiments shows detailed layers of PMR disk 104 in just one embodiment, and PMR disk 104 is in no way limited to this embodiment. PMR disk 104 includes a substrate 402 upon which other layers are formed. PMR disk 104 includes an adhesive layer 404 formed on substrate 402 that is comprised of AlTi. PMR disk 104 further includes an SUL structure formed on adhesion layer 404. The SUL structure is formed from a first SUL layer 406 of CoFeTaZr and a second SUL layer 410 of CoFeTaZr separated by an SUL coupling layer 408 of Ru. PMR disk 104 further includes three interlayers (or seed layers) formed on SUL layer 410. The interlayers includes a first interlayer 412 formed from CrTi, a second interlayer 414 formed from NiWCr, and a third interlayer 416 formed from Ru. PMR disk 104 further includes an exchange spring structure 430 formed on interlayer 416. The exchange spring structure 430 includes a magnetic recording layer 418 formed on interlayer 416, a coupling layer 420 formed on magnetic recording layer 418, and a cap layer 422 formed on coupling layer 420. Magnetic recording layer 418 is formed from CoPtCr—SiOx, and coupling layer 420 (also referred to as an exchange control layer) is formed from CoRu. Cap layer 422 (also referred to as an exchange spring layer) is formed from a CoPtCr alloy with a concentration of Cr in the range of about 15-22 at %, and a concentration of B in the range of about 0-6 at %. Overcoat layer 424 is formed on cap layer 422. Overcoat layer 424 protects the underneath layers against corrosion and damage if head-to-disk contact occurs.

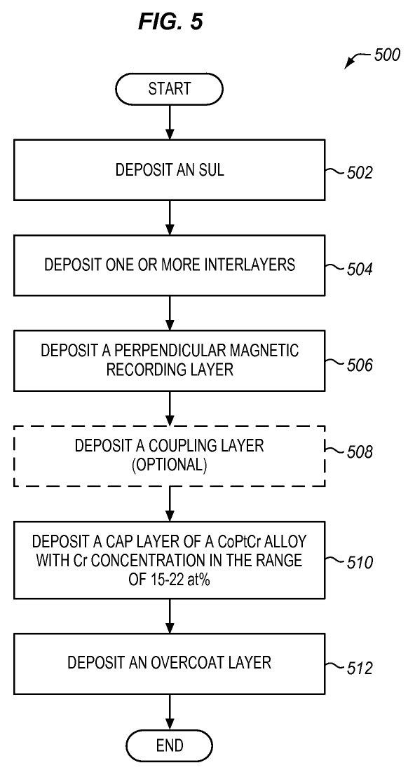

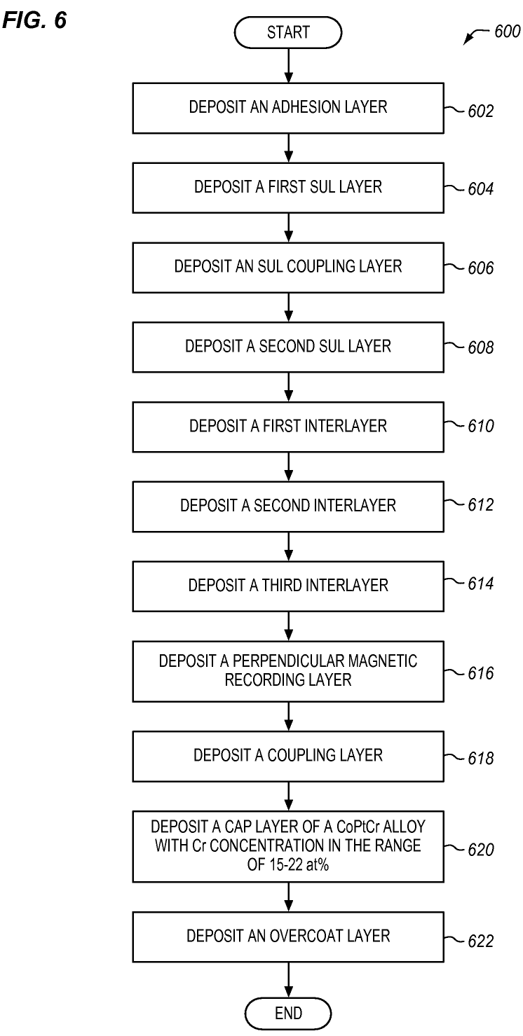

FIGS. 5-6 illustrate possible methods of fabricating PMR disks 104. FIG. 5 is a flow chart illustrating a method 500 of fabricating PMR disk 104 in an exemplary embodiment of the invention. Method 500 will be described as fabricating PMR disk 104 as illustrated in either FIG. 2 or FIG. 3. Method 500 is not all inclusive, and may include other steps not shown.

Step 502 comprises depositing or otherwise forming a SUL 204 on a substrate 202 (see FIGS. 2-3). In depositing the material for SUL 204, one layer of SUL material may be deposited, or multiple layers may be deposited such as for an AP-coupled structure. Step 504 comprises depositing or otherwise forming one or more interlayers 206 on SUL 204 (see FIGS. 2-3). Step 506 comprises depositing or otherwise forming a perpendicular magnetic recording layer 208 on interlayer 206 (see FIGS. 2-3). The material for the magnetic recording layer 208 may comprise CoPtCr—SiOx or another similar material.

Step 508 is an optional step of depositing or otherwise forming a coupling layer 302 on magnetic recording layer 208 (see FIG. 3). Coupling layer 302 may be formed from depositing CoRu or a similar material. Step 510 comprises depositing or otherwise forming a cap layer 210 (see FIGS. 2-3). Cap layer 210 may be formed on magnetic recording layer 208, as illustrated in FIG. 2, or may be formed on coupling layer 302, as illustrated in FIG. 3. Cap layer 210 is formed from a CoPtCr alloy having a concentration of Cr in the range of about 15-22 at %, and a concentration of B in the range of about 0-6 at %. Cap layer 210 may be deposited with a thickness in the range of about 2 to 8 nanometers. Step 512 comprises depositing or otherwise forming an overcoat layer 212 (see FIGS. 2-3).

FIG. 6 is a flow chart illustrating another method 600 of fabricating PMR disk 104 in an exemplary embodiment of the invention. Method 600 will be described as fabricating PMR disk 104 as illustrated in FIG. 4. Method 600 is not all inclusive, and may include other steps not shown.

Step 602 comprises depositing or otherwise forming an adhesion layer 404 on a substrate 402 (see FIG. 4). Adhesion layer 404 may comprise AlTi or a similar material. Step 604 comprises depositing or otherwise forming a first SUL layer 406 on adhesion layer 404. Step 606 comprises depositing or otherwise forming an SUL coupling layer 408 on the first SUL layer 406. Step 608 comprises depositing or otherwise forming a second SUL layer 410 on the coupling layer 408. SUL layers 406 and 410 may comprise CoFeTaZr and the SUL coupling layer 408 may comprise Ru.

Step 610 comprises depositing or otherwise forming a first interlayer 412 on the second SUL layer 410. First interlayer 412 may comprise CrTi or a similar material. Step 612 comprises depositing or otherwise forming a second interlayer 414 on the first interlayer 412. Second interlayer 414 may comprise NiWCr or a similar material. Step 614 comprises depositing or otherwise forming a third interlayer 416 on the second interlayer 414. Third interlayer 416 may comprise Ru or a similar material. Those skilled in the art will appreciate that more or less interlayers may be used as desired.

Step 616 comprises depositing or otherwise forming a magnetic recording layer 418 on the third interlayer 416. Magnetic recording layer 418 may comprise CoPtCr—SiOx or another CoPtCr alloy with an oxide dopant. Step 618 comprises depositing or otherwise forming a coupling layer 420 on magnetic recording layer 418. Coupling layer 420 may comprise CoRu or a similar material. Step 620 comprises depositing or otherwise forming a cap layer 422 on the coupling layer 420. Cap layer 422 is formed from a CoPtCr alloy having a concentration of Cr in the range of about 15-22 at %, and a concentration of B in the range of about 0-6 at %. Cap layer 422 may be deposited with a thickness in the range of about 2 to 8 nanometers. Step 622 comprises depositing or otherwise forming an overcoat layer 424 on the cap layer 422.

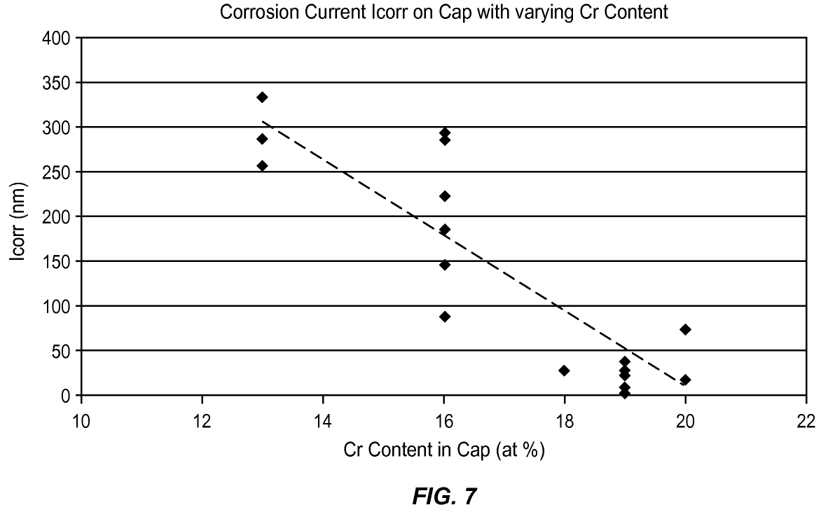

The PMR disks as described in the above embodiments advantageously provide superior magnetic recording performance while at the same time being less susceptible to corrosion. FIG. 7 is a graph illustrating the corrosion characteristics of a CoPtCr alloy. Corrosion current (Icorr) measures the susceptibility of an alloy to corrosion. The higher the current, the more likely the material is to corrode. As the Cr content increases in the CoPtCr alloy, the corrosion current decreases indicating that increased Cr in the alloy reduces the susceptibility to corrosion.

Although specific embodiments were described herein, the scope of the invention is not limited to those specific embodiments. The scope of the invention is defined by the following claims and any equivalents thereof.

We claim:

1. Perpendicular magnetic recording media, comprising:
a perpendicular magnetic recording layer; and
a cap layer formed directly on the magnetic recording layer, wherein the cap layer is formed from a CoPtCr alloy having a concentration of Cr in the range of about 15 to 22 atomic percent.

2. The perpendicular magnetic recording media of claim 1 wherein the CoPtCr alloy comprises CoPtCrB with a concentration of B in the range of about 0 to 6 atomic percent.

3. (canceled)

4. The perpendicular magnetic recording media of claim 1 wherein the thickness of the cap layer is in the range of about 2 to 8 nanometers.

5. Perpendicular magnetic recording media, comprising:
a soft magnetic underlayer (SUL) on a substrate;
at least one interlayer on the SUL;
a perpendicular magnetic recording layer on the at least one interlayer having an easy axis of magnetization oriented substantially perpendicular to the substrate;
a cap layer formed directly on the perpendicular magnetic recording layer;
wherein the cap layer is formed from a CoPtCr alloy having a concentration of Cr in the range of about 15 to 22 atomic percent.

6. The perpendicular magnetic recording media of claim 5 wherein the CoPtCr alloy comprises CoPtCrB with a concentration of B in the range of about 0 to 6 atomic percent.

7. The perpendicular magnetic recording media of claim 5 wherein:
the perpendicular magnetic recording layer is formed from CoPtCr-SiOx.

8. The perpendicular magnetic recording media of claim 5 wherein the thickness of the cap layer is in the range of about 2 to 8 nanometers.

9. The perpendicular magnetic recording media of claim 5 further comprising:
an overcoat layer on the cap layer to protect the cap layer.

10. A magnetic disk drive system, comprising:
a recording head; and
a perpendicular magnetic recording medium readable and writable by the recording head, the perpendicular magnetic recording medium comprising:
a perpendicular magnetic recording layer; and
a cap layer formed directly on the magnetic recording layer, wherein the cap layer is formed from a CoPtCr alloy having a concentration of Cr in the range of about 15 to 22 atomic percent.

11. The magnetic disk drive system of claim 10 wherein the CoPtCr alloy comprises CoPtCrB with a concentration of B in the range of about 0 to 6 atomic percent.

12. (canceled)

13. The magnetic disk drive system of claim 10 wherein the thickness of the cap layer is in the range of about 2 to 8 nanometers.

14. A method of fabricating perpendicular magnetic recording media, the method comprising:
depositing a soft magnetic underlayer (SUL) on a substrate;
depositing at least one interlayer on the SUL;
depositing a perpendicular magnetic recording layer on the at least one interlayer having an easy axis of magnetization oriented substantially perpendicular to the substrate; and
depositing a cap layer on the perpendicular magnetic recording layer;
wherein the cap layer is formed from a CoPtCr alloy having a concentration of Cr in the range of about 15 to 22 atomic percent.

15-16. (canceled)

17. The method of claim 16 further comprising:
depositing an overcoat layer on the cap layer to protect the cap layer.

18. The method of claim 16 wherein:
the perpendicular magnetic recording layer is formed from CoPtCr-SiOx.

19. The method of claim 14 wherein the CoPtCr alloy comprises CoPtCrB with a concentration of B in the range of about 0 to 6 atomic percent.

20. The method of claim 14 wherein the thickness of the cap layer is in the range of about 2 to 8 nanometers.
